(19) United States
(12) Patent Application Publication
(10) Pub. No.: US 2025/0085308 A1
(43) Pub. Date: Mar. 13, 2025

(54) TACHOMETER FOR AIR TURBINE MOTOR

(71) Applicant: First Eastern Equities Limited, Boca Raton, FL (US)

(72) Inventors: Keith Allen BOURNE, Chester, VA (US); James Murray PITTELKO, II, Newport News, VA (US); Logan Scott SCHORR, Henrico, CA (US)

(21) Appl. No.: 18/830,898

(22) Filed: Sep. 11, 2024

Related U.S. Application Data
(60) Provisional application No. 63/582,101, filed on Sep. 12, 2023.

(51) Int. Cl. G01P 3/36; F01D 21/00; H04Q 9/00

(52) U.S. Cl. CPC G01P 3/36; F01D 21/003; H04Q 9/00; F05D 2260/83; H04Q 2209/40

(57) ABSTRACT

A tachometer system for high-torque rotor for a handheld or spindle-mounted pneumatic tool. There are three main components of the tachometer system. This first main component is a measuring module that includes a photodetector electrically coupled to a cable. The measuring module is fastened inside an air turbine motor assembly with a plurality of exhaust ports. The measuring module is sized to fit within an exhaust bore of the air turbine motor assembly. In one example, the measuring module includes a photodetector mounting plug for firmly holding the photodetector in the exhaust bore of the air turbine motor assembly. Another example of the measuring module includes a photodetector mounting plug for firmly holding the photodetector in the exhaust bore of the air turbine motor assembly.

### CROSS-REFERENCE TO RELATED APPLICATIONS

This application is related to and claims priority to U.S. Provisional Patent Application No. 63/582,101, entitled “TACHOMETER FOR AIR TURBINE MOTOR” filed on Sep. 12, 2023, both of which are assigned to the same assignee as this application and the teachings of both which are herein incorporated by reference in its entirety.

### FIELD OF THE INVENTION

This disclosure generally relates to pneumatically powered, handheld, or spindle-mounted BMT (Base mounted tool) suitable for milling, drilling, grinding, polishing, and, more particularly, to measuring the speed of a turbine motor.

### BACKGROUND

Rotary tools have been used for a variety of functions, such as grinding, polishing, metal or plastic finishing, engraving, milling, drilling, and deburring. The tool variations include handheld and machine spindle-mounted embodiments.

Computer Numerical Control (CNC) machines are utilized in machining processes and utilize a computer controller that typically reads G-code instructions for driving a powered mechanical device that is typically used to fabricate metal components by the selective removal of metal. CNC can do numerically directed interpolation of a cutting tool in the work envelope of a machine.

The powered mechanical device is often a pneumatic tool (e.g., a drill) that is fitted for coupling with the CNC machine, such as by insertion into and withdrawal from a CNC machine. The pneumatic tools or spindles can be manually coupled with the CNC machine, or an automatic tool changer can be utilized.

### SUMMARY OF THE INVENTION

Disclosed is a novel tachometer system for high-torque rotor for a handheld or spindle-mounted pneumatic tool. There are three main components of the tachometer system. This first main component is a measuring module that includes a photodetector electrically coupled to a cable. The measuring module is fastened inside an air turbine motor assembly with a plurality of exhaust ports. The measuring module is sized to fit within an exhaust bore of the air turbine motor assembly. In one example, the measuring module includes a photodetector mounting plug for firmly holding the photodetector in the exhaust bore of the air turbine motor assembly. Another example of the measuring module includes a photodetector mounting plug for firmly holding the photodetector in the exhaust bore of the air turbine motor assembly.

In still another example, the measuring module includes a circuit board mechanically coupled to a substrate and the substrate is mechanically coupled to an interior wall of the air turbine motor assembly with a screw-type fastener.

The measuring module may further include a barometer to measure air pressure within the air turbine motor assembly. The transmitting module is configured to begin wirelessly transmitting data once the air pressure meets a settable threshold within the air turbine motor assembly. The wireless transmitting includes wireless transmitting over Bluetooth, near-field communications, or Wi-Fi.

The second main component is the cable is formed to pass through one of the plurality of exhaust ports. The third main component is a transmitting module electrically coupled to the cable and positioned external to the air turbine motor assembly. The transmitting module includes a transmitter for wirelessly transmitting measurements from the measuring module and a battery.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a perspective view of a prior art machining system;

FIG. 2 is a perspective view of another portion of the prior art system of FIG. 1;

FIG. 3 is a side view of a lower portion of a prior art dual chamber air turbine motor;

FIG. 4 is a cross-sectional side prior art view of FIG. 3, taken along line A-A′ illustrating the interior portions of the prior art dual camber motor;

FIG. 5 is a perspective view of a prior art air turbine motor;

FIG. 6 is a perspective view of the air turbine motor of FIG. 5 retrofitted with a tachometer showing the transmitting module mounted below the mounting collar, according to an example embodiment of the present invention;

FIG. 7 is a cross-sectional view of FIG. 6 retrofitted with the tachometer showing the transmitting module mounted below the mounting collar, according to an example embodiment of the present invention;

FIG. 8 is a more detailed cross-sectional view of FIG. 7 illustrates one of the exhaust passages in which the transmitting module is mounted, according to an example embodiment of the present invention;

FIG. 9 is a detailed cross-sectional view of the measuring module mounted on a conductive substrate placed into the exhaust passage of FIG. 8, according to an example embodiment of the present invention;

FIG. 10 is a detailed cross-sectional view of FIG. 9 illustrating how an Allen screw-type fastener with an Allen wrench is used to mechanically fasten the measuring module into the exhaust passage, according to an example embodiment of the present invention;

FIGS. 11A through 11E is a schematic of the tachometer measuring module and transmitting unit, according to an example embodiment of the present invention; and

FIGS. 12A through 12B is a diagram of the machine system and the various items measured, including the speed of the turbine using the tachometer of FIG. 7 through FIG. 11, according to an example embodiment of the present invention.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

The present invention provides an air turbine motor spindle assembly for handheld or machine-mounted applications. The main difference between the air turbine motor spindle assembly live tooling rotor and other commercially available motors is that the air turbine motor spindle assembly has a governed turbine instead of a drum-style rotor. A governed turbine gives the pneumatic tool far superior power than the alternative. The main similarity of the present invention is the external dimensions and visual appearance. The turbine motor spindle assembly has a shank bolt-hole pattern to fit within the holder of live tooling machines, including Swiss-style machines and BMT (Base Mount Tools).

The rotor governor assembly used in the prototype of the present invention is a modified version of an existing Air Turbine rotor as described in U.S. Pat. No. 4,776,752 entitled “Speed Governed Rotary Device” (the '752 patent) and U.S. Pat. No. 7,077,732 entitled “High Torque, Dual Chamber Turbine Rotor for Handheld or Spindle Mounted Pneumatic Tool” (the '732 patent) the teachings of each patent are incorporated by reference in their entirety. Another embodiment is a modified version of an existing Air Turbine Rotor as described in U.S. Pat. No. 11,498,172 entitled “Dual speed rotary tool” (the '172 patent), the teachings of this patent are incorporated by reference in its entirety.

### Non-Limiting Terminology

The terms “a” or “an,” as used herein, are defined as one or more than one. The term plurality, as used herein, is defined as two or more than two. The term another, as used herein, is defined as at least a second or more.

The term air turbine rotor and air turbine rotor housing are components of an air turbine motor or air turbine spindle motor that uses compressed gas, such as air, to power the turbine.

The term “and” in the phrase “one of A, B, and C” means either A or B or C or any combination of A, B, and C.

The term “air” is intended to broadly cover many different types of fluids, including oil mixed with air.

The phrase “air intake passage” is the passageway in which compressed air is introduced into an air inlet that communicates with an axial opening in a drive shaft that drives the turbine rotor.

The term “coupled,” as used herein, is defined as “connected” although not necessarily directly and not necessarily mechanically.

The phrase “exhaust air passage” is the passage from the turbine motor housing that expels air tangentially from the air turbine rotor through to the end portion of the turbine motor spindle assembly, which is opposite the collet nut.

The terms “including” and “having” as used herein are defined as comprising (i.e., open language).

Various materials or combinations of materials can be used to construct the mounting collar and its components. For example, materials such as metals, alloys, composites, plastics, ceramics, and other inorganic or organic materials or combinations thereof may be used.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

### Machining System and Spindles

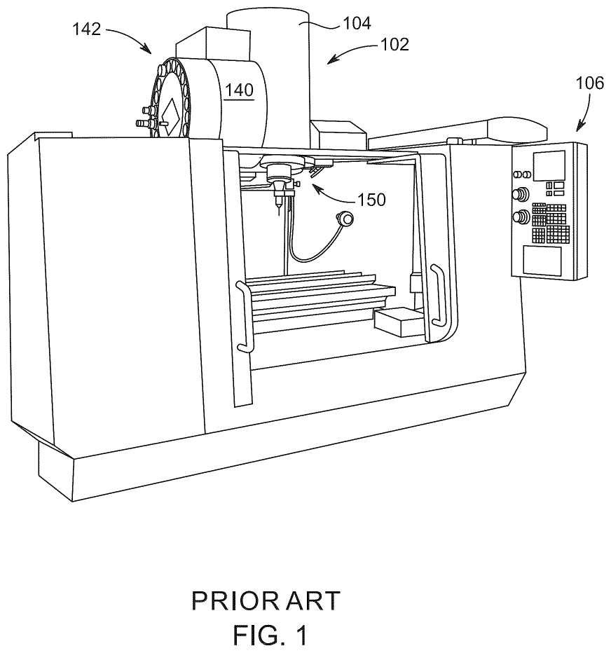

Referring to the drawings, and in particular to FIG. 1, a machining system is shown and generally represented by reference numeral 102. System 102 can include a control device 104, such as a CNC machine, a tool carousel 140, and one or more tools or spindles 142. The spindle or air turbine motor 150 are a motorized component of a CNC machine that holds and rotates cutting tools such as drills, end mills, or router bits. It provides the necessary power and speed for cutting, shaping, or drilling operations during the machining process. The control device 104 can include a user input device 106 for inputting commands. The control device 104 can utilize various computational hardware and software to implement a machining process on a workpiece, and the present disclosure is not intended to be limited based upon the type of control utilized.

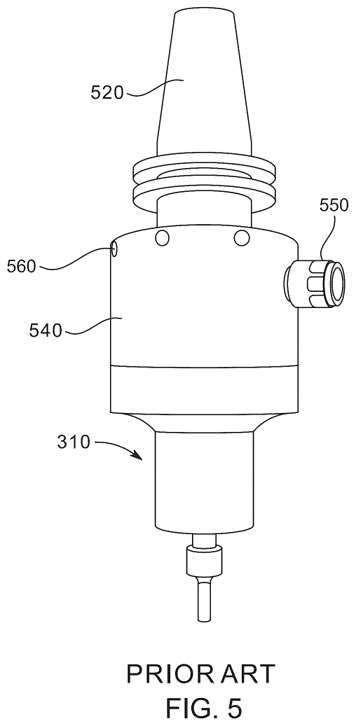

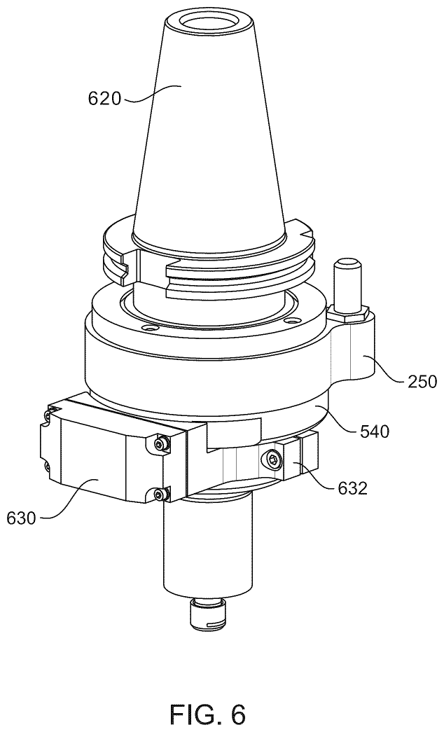

The system 102 can also have a universal spindle mounting assembly (USMA) (520 of FIG. 5 and 620 of FIG. 6) that cooperates with the spindles 142 to allow for automatic exchanging of the spindles with the CNC machine 104. In the exemplary embodiment of system 102, the spindles 142 are exchanged between the CNC machine 104 and the tool carousel 140 by way of an autochanger device. However, the present disclosure contemplates using other structures and techniques for connecting and disconnecting the spindles 142 with the CNC machine 104 through the use of the USMA (520 of FIG. 5 and 620 of FIG. 6), such as a linear carousel.

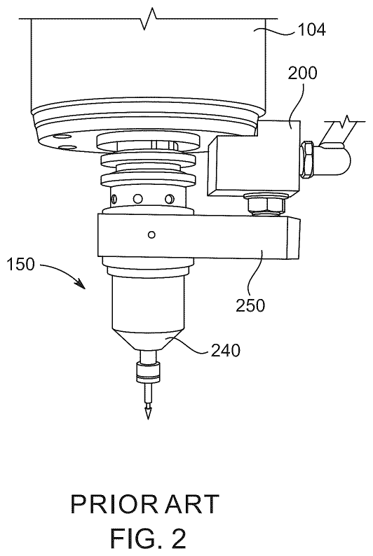

The USMA (520 of FIG. 5 and 620 of FIG. 6) can include a mounting collar 250 and a mounting block 200, as shown more clearly in FIG. 2. The mounting collar 250 can be operably coupled to the spindle or air turbine motor 150, while the mounting block 200 can be operably coupled to the CNC machine 104. The mounting collar 250 includes an internal air passage for providing compressed gas via the mounting block 200 to power the spindle or air turbine motor 150.

The air turbine motor 150 from Air Turbine Tools Inc. includes a governor that helps to maintain the speed of the air turbine steady regardless of load, i.e., the amount of work that the air turbine motor must perform. However, there is no feedback mechanism to relay actual speed to users. This prevents adoption by customers who require speed monitoring for quality control, troubleshooting, and/or regulatory purposes.

### Air Turbine Motor

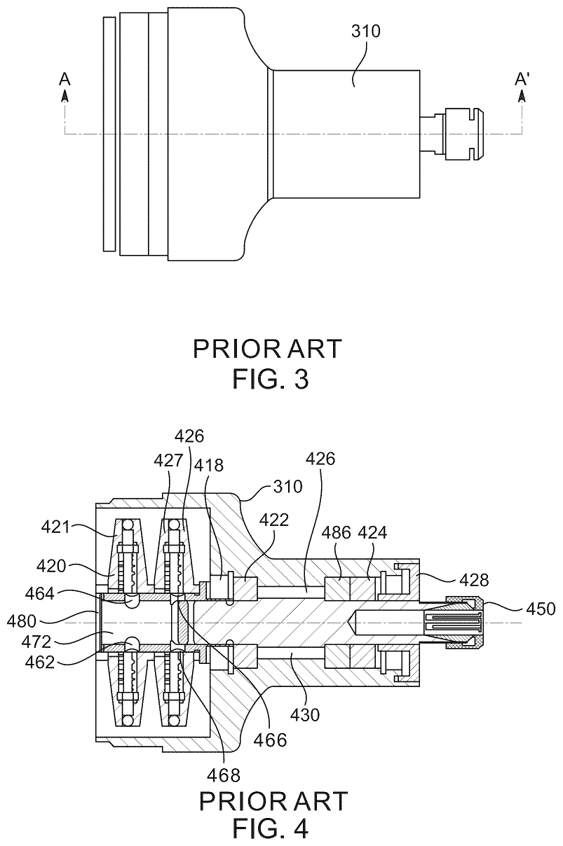

Turning now to FIG. 3 is a sideview of the lower portion 240 of the spindle or air turbine motor 150 with a dual chamber turbine rotor body 310. FIG. 4 is a cross-sectional side view of FIG. 3 taken along line A-A′. Air or pressurized fluid enters into the axial bore 480 of the shaft 472. The outer wall comprises a first set of one or more hollow openings 462, 464 at a first position from the shaft 472.

The outer wall comprises a second set of hollow openings 466, 468 at a second position from the top of the shaft 472. The axial bore 480 that, is in fluid communications with the hollow openings 464, 466 provides pressurized air to both the first annular chamber 420, with a first turbine 421 shown disposed within, and the second annular chamber 426, shown with a second turbine 427 shown disposed within.

The hollow openings 462, 464 is typically formed in sets of two or more at various radial a position on the shaft 460. In this embodiment, there is another hollow opening (not shown) formed on the back side of the shaft 472, i.e., 180 degrees from the openings 462, 464. This set of two or more hollow openings 462, 464 helps to maintain the balance of the shaft 472 and rotor. Likewise, hollow openings 464, 466 include another opening on the back side (not shown).

Continuing further down the shaft 472 towards the cutting or polishing bit held in place by collet nut 450 is a spanner nut 418, bearings 422, empty space or void 430 and annular chamber 426 separated by a bearings stop 486, bearings 424. A deflector 428 is used to protect the bearing 424.

FIG. 5 is a perspective view of an air turbine motor 540, such as Air Turbine Tools, 650 Series. Shown is an air intake 550, in applications that do not use the mounting collar 250 of FIG. 2. The compressed air powers the internal air turbines, which powers the cutting bit 530. Compressed air from the internal air turbine exits the air turbine motor 540 through one or more exhaust ports 560.

### Tachometer

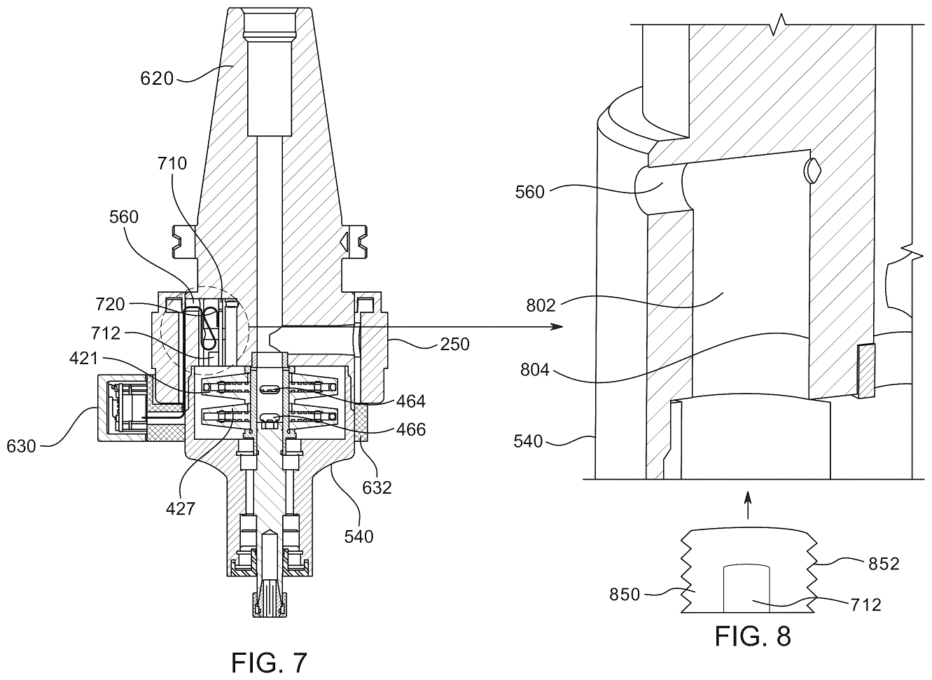

Referring now to FIG. 6, shown is a perspective view of the spindle or air turbine motor 150 of FIG. 2 retrofitted with a tachometer showing the transmitting module mounted below the mounting collar 250, according to an example embodiment of the present invention. There are three major components to the tachometer. The first component is a measuring module (shown below in FIG. 7) disposed internal to the air turbine motor, as more fully described below. The second component is a cable (shown below in FIG. 7) that electrically couples the measuring module to the third component. The third component is a transmitting module 630 disposed on the outside of the air turbine motor 540 using a mounting system clamp 632, as shown.

FIG. 7 is a cross-sectional view of FIG. 6 retrofitted with the tachometer. All three major components are shown as follows: i) the measuring module 710, ii) the cable 720, and iii) the transmitting module 630. The bottom of the measuring module 630 includes a photodetector 712 for measuring the rotations of the turbine. In one example, the turbine is marked with dark and white regions to enable the photodetector to detect each revolution more accurately.

FIG. 8 is a more detailed cross-sectional view of FIG. 7 illustrates one of the exhaust port 560 in which the measuring module is mounted in exhaust channel 802, with an enlarged inner bore 804 for holding the photodetector 712 in proximity to the upper turbine or first turbine 421, as shown.

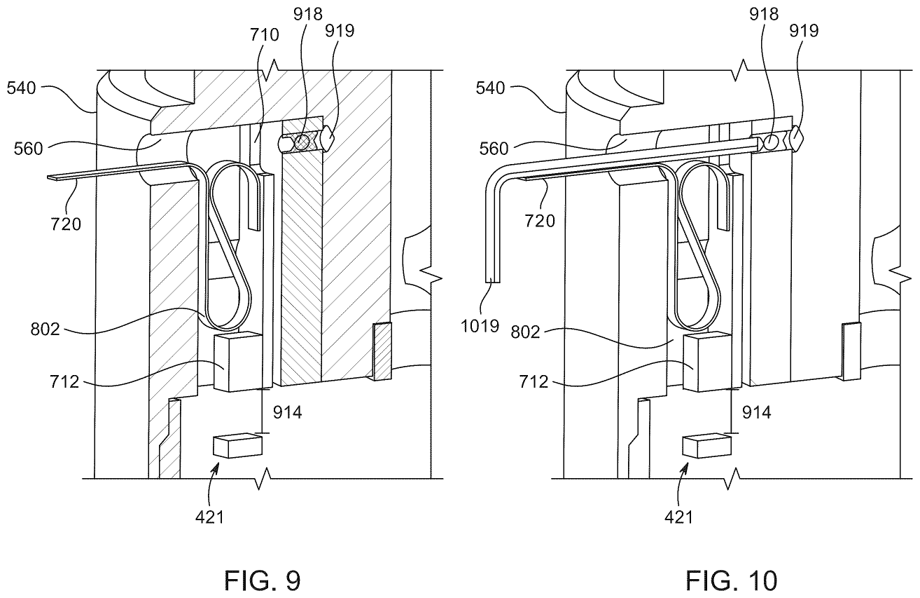

FIG. 9 is a detailed cross-sectional view of the measuring module 710 is placed onto an interior wall of the exhaust channel 802. The measuring module may be mounted on a substrate, in addition to a circuit board (not shown). The photodetector 712 is mounted just above the first turbine 421 with a gap 914 therebetween. Also shown is a hex-type screw fastener 918 mechanically engaging recess 919 to hold the measuring module 630 firmly attached.

In another embodiment, a photodetector mounting plug 852 whose shape matches the enlarged inner bore 804 and firmly holds the photodetector 712 may be used. The photodetector mounting plug in one example, includes a series of ridges 852 to help firmly hold it in place. This embodiment eliminates the need for the hex-screw holder. The photodetector mounting plug can be manufactured from plastic using additive printing, such as 3D printing. Other materials, such as rubber and manufacturing methods of plugs, such as molds, may also be used.

FIG. 10 is a detailed cross-sectional view of FIG. 9 illustrating how the hex-type screw fastener 918 with an Allen wrench 1019 placed in exhaust passage or exhaust port 560 is used to mechanically fasten the measuring module 630 to an interior wall 804 of the exhaust channel 802.

### Circuit

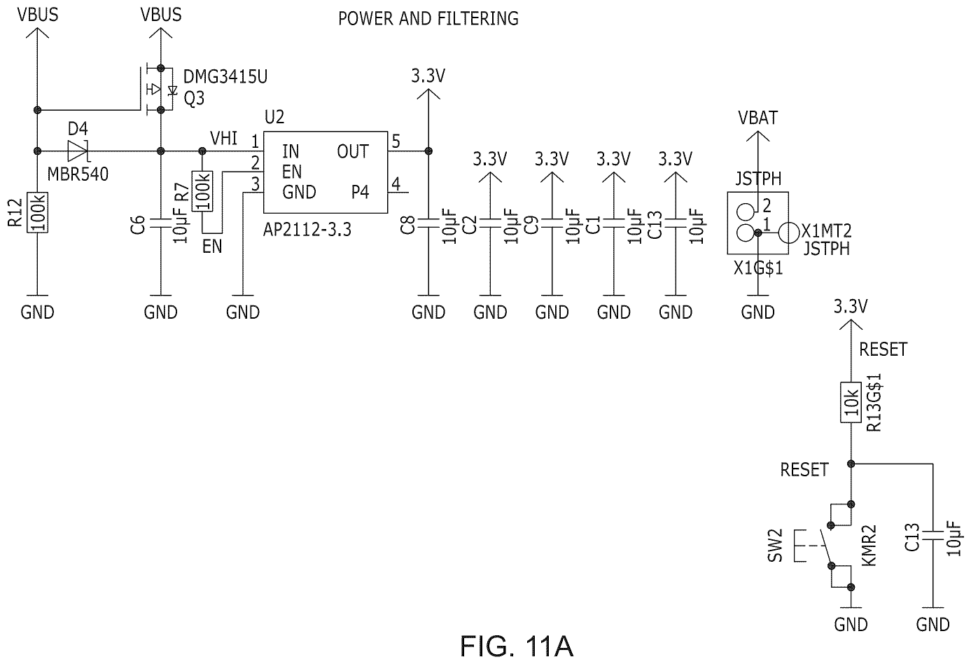

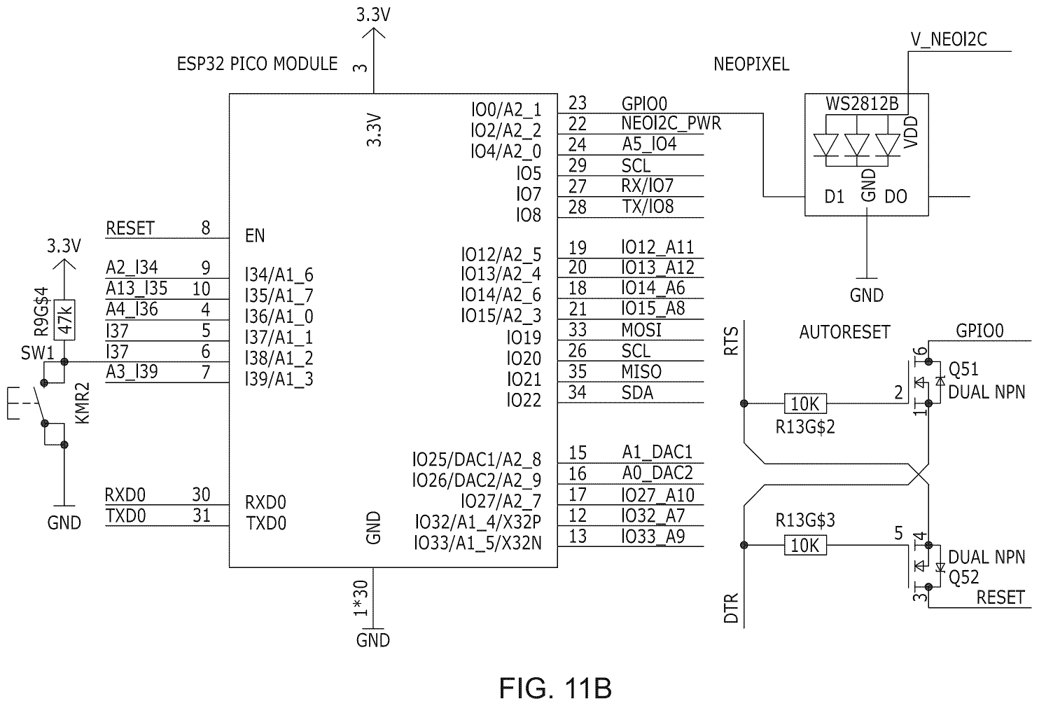

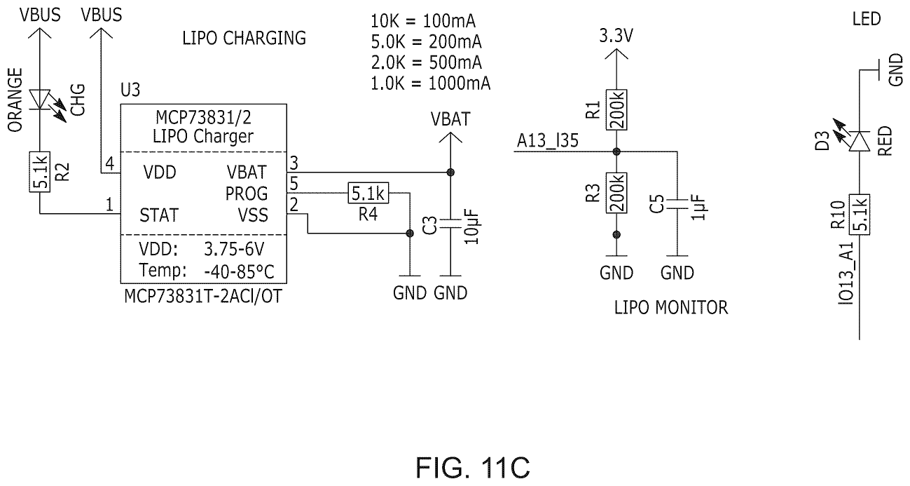

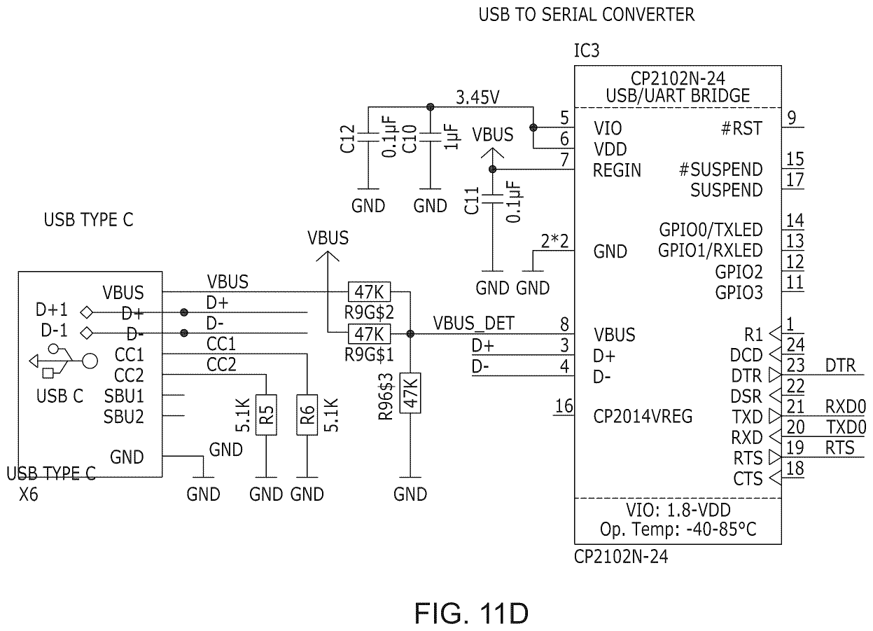

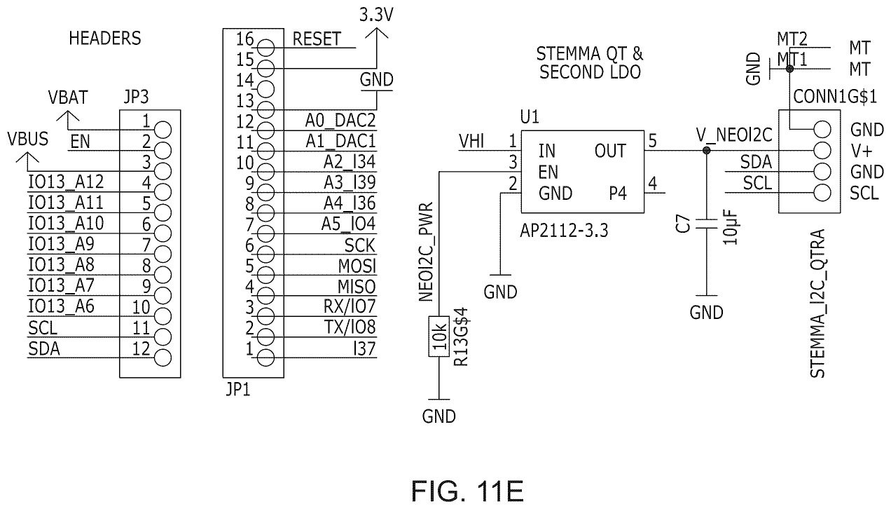

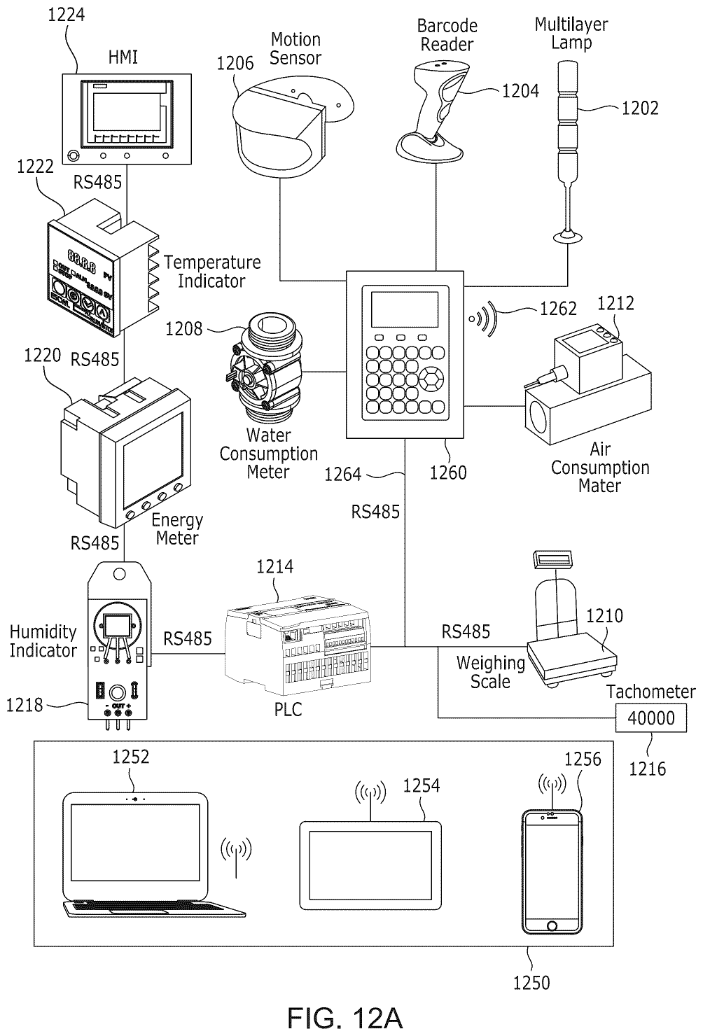

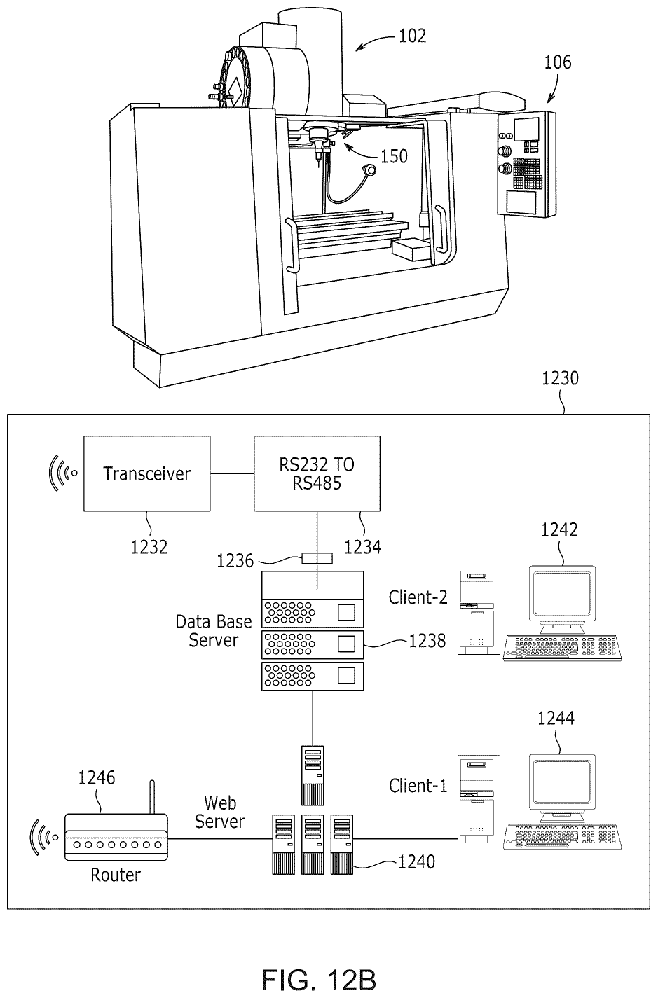

FIGS. 11A through 11E is a schematic of the tachometer measuring module and transmitting unit, according to an example embodiment of the present invention. The schematic includes a power source, such as a battery. Although this example provides Bluetooth wireless communications, as described with reference to FIGS. 12A through 12B below, other wireless communications methods may be used. Further functional and programming guides can be found here <https://docs.espressif.com/projects/esp-idf/en/stable/esp32/hw-reference/esp32/get-started-pico-kit.html> and other references cited in the Information Disclosure Statement which the teachings of each are hereby incorporated individually by reference in its entirety.

In addition, to preserve battery life, the circuit may include a barometer, such as a BMP180 sensor cited in the Information Disclosure Statement. The transmitting module of the circuit is configured to begin wirelessly transmitting data once the air pressure meets a settable threshold within the air turbine motor assembly.

### Machining Environment

FIGS. 12A through 12B is a diagram 1200 of the machining system 102 and the various items measured, including the speed of the turbine using the tachometer of FIG. 7 through FIG. 10, according to an example embodiment of the present invention. The machining system 102 includes a user input device 106. The user input device in one example is communicatively coupled to another controller 1260 or maybe the same device. The controller is connected to wired network 1264 or wireless communications network 1262 to one or more optional devices, as shown. The wired connection may be over ethernet, RS485 or any other communication bus. Wireless communications network 1262 includes Bluetooth, NCF, Wi-Fi, and cellular. The wireless communications network 1262, in one example, communicatively couples with the transmitting module 630. Further, the wireless communications network 1262 may also communicatively couple with a computer network 1230. The optional devices shown as part of a wired network include:
A status light 1202 for operators to visually confirm if the machining system is currently operating.
A barcode reader 1204 allows barcoded parts and items to be automatically entered into a tracking system.
A motion detector 1206 is used as a security precaution to sense if anyone enters a designated work area.
A water meter 1208 to measure water consumption used by the machining system 102.
A scale 1210 to weigh parts and assemblies before and/or after machining
An air consumption meter 1212 to measure airflow through the machining system 102 and spindles 150
A PLC (programmable logic controller) 1214 is an industrial computer that is typically ruggedized and adapted for the control of manufacturing processes, such as assembly lines, machines, robotic devices, or any activity that requires high reliability, ease of programming, and process fault diagnosis.
A tachometer display 1216 to display the current speed of the air turbine motor 150 in machining system 102.
A humidity indicator 1218 to measure ambient humidity.
An energy meter 1220 to measure electrical consumption.
A temperature indicator 1222 is used to measure temperature.
A display 1224 to display the status of one or more of the optional items above.

The computer network 1230, as stated above, may wireless connect with the controller 1260. The computer network includes a wireless transceiver 1232, which is communicatively coupled to a wired network converter 1234. The wired network converter 1234 communicates over a wired network 1236 with computer systems, such as database server 1238 and web server 1240. The wired network 1236 is also communicatively coupled to one or more client machines, 1242 and 1244, and a wireless router 1246. The wireless router allows other wireless clients to communicate with laptop 1252, tablet 1254, and handheld device 1256, including information from optional devices above. Also, the wireless router 1246 is depicted as a local wireless hotspot, the present invention may communicate over any wired or wireless network, including the Internet and Cellular networks.

### Non-Limiting Examples

The instant invention has been shown and described herein in what is considered to be the most practical and preferred embodiment. It is recognized, however, that departures may be made therefrom within the scope of the invention and that obvious modifications will occur to a person skilled in the art.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed as the best mode contemplated for carrying out this invention, but that the invention will include all embodiments falling within the scope of the appended claims.

What is claimed is:

1. A tachometer comprising:
a measuring module including a photodetector electrically coupled to a cable, the measuring module is fastened inside an air turbine motor assembly with a plurality of exhaust ports, and the cable is formed to pass through one of the plurality of exhaust ports; and
a transmitting module electrically coupled to the cable and positioned externally to the air turbine motor assembly, the transmitting module includes a transmitter for wirelessly transmitting measurement from the measuring module and a battery.

2. The tachometer of claim 1, wherein the measuring module is sized to fit within an exhaust bore of the air turbine motor assembly.

3. The tachometer of claim 2, wherein the measuring module includes a photodetector mounting plug for firmly holding the photodetector in the exhaust bore of the air turbine motor assembly.

4. The tachometer of claim 1, wherein the measuring module further includes a barometer to measure air pressure within the air turbine motor assembly.

5. The tachometer of claim 4, wherein the transmitting module is configured to begin wirelessly transmitting data once the air pressure meets a settable threshold within the air turbine motor assembly.

6. The tachometer of claim 1, wherein the wireless transmitting includes wireless transmitting over Bluetooth, near-field communications, or Wi-Fi.

7. The tachometer of claim 1, wherein the measuring module includes a circuit board mechanically coupled to a substrate and the substrate is mechanically coupled to an interior wall of the air turbine motor assembly with a screw-type fastener.

8. A high-torque rotor for a handheld or spindle-mounted pneumatic tool, comprising:
a drive shaft with a first end, a second end, and an outer wall, the first end including an axial bore and a first set of openings in the outer wall at a first position from the first end and a second set of openings in the outer wall at a second position from the first end, the axial bore in fluid communications with the first set of openings and the second set of openings and the second end including a collet nut assembly;
an air turbine rotor having a first annular chamber in fluid communication with the first set of openings of the drive shaft and a second annular chamber in fluid communications with the second set of openings in the drive shaft and the air turbine rotor including a set of tangential openings for exhaust air from the air turbine rotor;
an air turbine rotor housing with an external side wall, the air turbine rotor housing surrounds the air turbine rotor, the air turbine rotor housing has a set of passages in fluid communications with a set of openings in the external side wall that directs exhaust air from the set of tangential openings of the air turbine rotor out through the side external wall;
a measuring module including a photodetector electrically coupled to a cable, the measuring module fastened inside the air turbine rotor housing, the cable passing through one of the set of openings in the external side wall of the air turbine rotor housing; and
a transmitting module electrically coupled to the cable and positioned externally to the air turbine rotor housing, the transmitting module includes a battery and a transmitter for wirelessly transmitting measurements from the measuring module.

9. The high-torque rotor of claim 8, wherein the measuring module is sized to fit within an exhaust bore of the air turbine rotor housing.

10. The high-torque rotor of claim 9, wherein the measuring module includes a photodetector mounting plug for firmly holding the photodetector in the exhaust bore of the air turbine rotor housing.

11. The high-torque rotor of claim 8, wherein the measuring module further includes a barometer to measure air pressure within the air turbine rotor housing.

12. The high-torque rotor of claim 11, wherein the transmitting module is configured to begin wirelessly transmitting data once the air pressure meets a settable threshold within the air turbine rotor housing.

13. The high-torque rotor of claim 8, wherein the wireless transmitting data includes wireless transmitting data over Bluetooth, near field communications, or Wi-Fi.

14. The high-torque rotor of claim 8, wherein the measuring module includes a circuit board mechanically coupled to a substrate and the substrate is mechanically coupled to an interior wall of the air turbine rotor housing with a screw-type fastener.
